(19) United States
(12) Patent Application Publication
(10) Pub. No.: US 2025/0176090 A1
(43) Pub. Date: May 29, 2025

(54) PERFORMANCE RECOVERY METHOD FOR EUV LIGHT GENERATION SYSTEM, EUV LIGHT GENERATION SYSTEM, AND PROCESSOR

(71) Applicant: Gigaphoton Inc., Tochigi (JP)

(72) Inventors: Yuichi NISHIMURA, Oyama-shi (JP); Yoshifumi UENO, Oyama-shi (JP)

(73) Assignee: Gigaphoton Inc., Tochigi (JP)

(21) Appl. No.: 18/905,470

(22) Filed: Oct. 3, 2024

(30) Foreign Application Priority Data
Nov. 28, 2023 (JP) 2023-200981

(51) Int. Cl. H05G 2/00

(52) U.S. Cl. CPC H05G 2/009; H05G 2/0082

(57) ABSTRACT

A performance recovery method for an EUV light generation system includes performing a first evaluation step of evaluating performance of EUV light while generating the EUV light at a certain repetition frequency during a first period; performing, when an evaluation result of the first evaluation step is not within a normal range, an adjustment step of adjusting the performance and then the first evaluation step as a check step; performing, when an evaluation result of the check step is within the normal range, a second evaluation step of evaluating performance of the EUV light while generating the EUV light at the repetition frequency during a second period longer than the first period; and terminating processing when the evaluation result of the check step is not within the normal range. An index related to an irradiation position of pulse laser light is evaluated in the first and second evaluation steps.

### CROSS-REFERENCE TO RELATED APPLICATIONS

The present application claims the benefit of Japanese Patent Application No. 2023-200981, filed on Nov. 28, 2023, the entire contents of which are hereby incorporated by reference.

### BACKGROUND

### 1. Technical Field

The present disclosure relates to a performance recovery method for an EUV light generation system, an EUV light generation system, and a processor.

### 2. Related Art

Recently, miniaturization of a transfer pattern in optical lithography of a semiconductor process has been rapidly proceeding along with miniaturization of the semiconductor process. In the next generation, microfabrication at 10 nm or less will be required. Therefore, it is expected to develop a semiconductor exposure apparatus that combines an apparatus for generating extreme ultraviolet (EUV) light having a wavelength of about 13 nm with a reduced projection reflection optical system.

A system including a laser produced plasma (LPP) type EUV light generation apparatus using plasma generated by irradiating a target substance with laser light has been developed.

### LIST OF DOCUMENTS

### Patent Documents

Patent Document 1: Japanese Patent Application Publication No. S63-138732
Patent Document 2: Japanese Patent Application Publication No. 2013-074132
Patent Document 3: Japanese Patent Application Publication No. 2013-167971

### SUMMARY

A performance recovery method, according to an aspect of the present disclosure, for an EUV light generation system generating EUV light by irradiating a target with pulse laser light, includes performing a first evaluation step of evaluating performance of the EUV light while generating the EUV light at a certain repetition frequency during a first period; performing, when an evaluation result of the first evaluation step is not within a normal range, an adjustment step of adjusting the performance and then the first evaluation step as a check step; performing, when an evaluation result of the check step is within the normal range, a second evaluation step of evaluating performance of the EUV light while generating the EUV light at the repetition frequency during a second period longer than the first period; and terminating processing when the evaluation result of the check step is not within the normal range. Here, an index related to an irradiation position of the pulse laser light with respect to the target is evaluated in the first evaluation step and the second evaluation step.

An EUV light generation system generating EUV light by irradiating a target with pulse laser light according to an aspect of the present disclosure includes a processor. The processor is configured to perform a first evaluation step of evaluating performance of the EUV light while generating the EUV light at a certain repetition frequency during a first period; perform, when an evaluation result of the first evaluation step is not within a normal range, an adjustment step of adjusting the performance and then the first evaluation step as a check step; perform, when an evaluation result of the check step is within the normal range, a second evaluation step of evaluating performance of the EUV light while generating the EUV light at the repetition frequency during a second period longer than the first period; and terminate processing when the evaluation result of the check step is not within the normal range. Here, an index related to an irradiation position of the pulse laser light with respect to the target is evaluated in the first evaluation step and the second evaluation step.

A processor, according to an aspect of the present disclosure, to be used for an EUV light generation system generating EUV light by irradiating a target with pulse laser light is configured to perform a first evaluation step of evaluating performance of the EUV light while generating the EUV light at a certain repetition frequency during a first period; perform, when an evaluation result of the first evaluation step is not within a normal range, an adjustment step of adjusting the performance and then the first evaluation step as a check step; perform, when an evaluation result of the check step is within the normal range, a second evaluation step of evaluating performance of the EUV light while generating the EUV light at the repetition frequency during a second period longer than the first period; and terminate processing when the evaluation result of the check step is not within the normal range. Here, an index related to an irradiation position of the pulse laser light with respect to the target is evaluated in the first evaluation step and the second evaluation step.

### BRIEF DESCRIPTION OF THE DRAWINGS

Embodiments of the present disclosure will be described below merely as examples with reference to the accompanying drawings.

FIG. 1 is a view schematically showing the configuration of an LPP EUV light generation system.

FIG. 2 is a view showing the configuration of the EUV light generation system according to a comparative example.

FIG. 3 is a graph showing an example of operation of the EUV light generation system according to the comparative example.

FIG. 4 is a flowchart showing the flow of performance recovery processing according to the comparative example.

FIG. 5 is a view showing the configuration of the EUV light generation system according to a first embodiment.

FIG. 6 is a flowchart showing the flow of performance recovery processing according to the first embodiment.

FIG. 7 is a flowchart showing an example of an adjustment step with short bursts under open loop.

FIG. 8 is a flowchart showing an example of the adjustment step with long bursts under open loop.

FIG. 9 is a flowchart showing the flow of performance recovery processing according to a second embodiment.

FIG. 10 is a flowchart showing the flow of performance recovery processing according to the second embodiment.

### DESCRIPTION OF EMBODIMENTS

### Contents

1. Overall description of EUV light generation system
   1.1 Configuration
   1.2 Operation
2. EUV light generation system according to comparative example
   2.1 Configuration
   2.2 Operation
   2.3 Problem
3. EUV light generation system according to first embodiment
   3.1 Configuration
   3.2 Operation
   3.3 Effect
4. EUV light generation system according to second embodiment
   4.1 Configuration
   4.2 Operation
   4.3 Effect

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Overall Description of EUV Light Generation System

### 1.1 Configuration

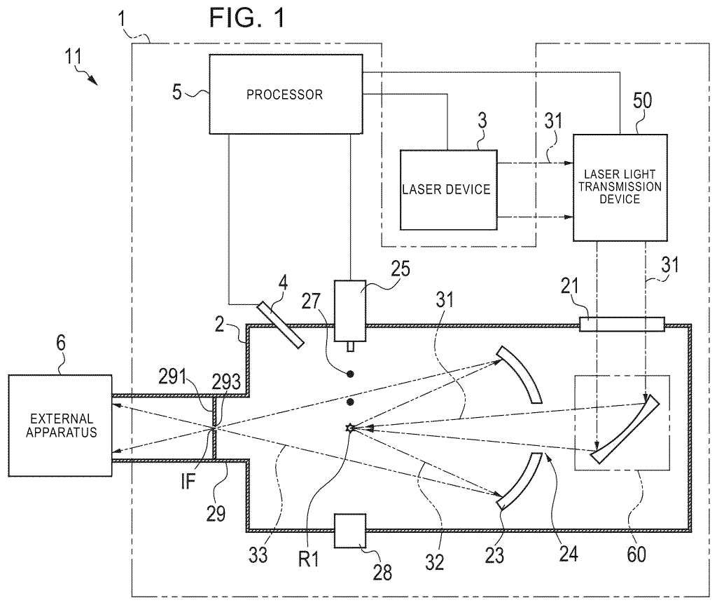

FIG. 1 schematically shows the configuration of an LPP EUV light generation system 11. An EUV light generation apparatus 1 is used together with a laser device 3. In the present disclosure, a system including the EUV light generation apparatus 1 and the laser device 3 is referred to as the EUV light generation system 11. The EUV light generation apparatus 1 includes a chamber 2 and a target supply device 25. The chamber 2 is a sealable container. The target supply device 25 supplies a target 27 into the chamber 2. The material of the target 27 may include tin, terbium, gadolinium, lithium, xenon, or a combination of any two or more thereof.

A through hole is provided in a wall of the chamber 2. The through hole is blocked by a window 21 through which pulse laser light 31 output from the laser device 3 passes. An EUV light concentrating mirror 23 having a spheroidal reflection surface is arranged inside the chamber 2. The EUV light concentrating mirror 23 has first and second focal points. A multilayer reflection film in which molybdenum and silicon are alternately stacked is formed on a surface of the EUV light concentrating mirror 23. The EUV light concentrating mirror 23 is arranged such that the first focal point is located in a plasma generation region R1 and the second focal point is located at an intermediate focal point IF. A through hole 24 is formed at the center of the EUV light concentrating mirror 23, and the pulse laser light 31 passes through the through hole 24.

The EUV light generation apparatus 1 includes a processor 5, a target sensor 4, and the like. The target sensor 4 detects the presence, trajectory, position, velocity, and the like of the target 27. The target sensor 4 may have an imaging function.

Further, the EUV light generation apparatus 1 includes a connection portion 29 providing communication between the inside of the chamber 2 and the inside of an external apparatus 6. A wall 291 in which an aperture 293 is formed is arranged in the connection portion 29. The wall 291 is arranged such that the aperture 293 is located at the second focal point of the EUV light concentrating mirror 23. For example, the external apparatus 6 is an exposure apparatus.

Further, the EUV light generation apparatus 1 includes a laser light transmission device 50, a laser light concentrating optical system 60, and a target collection unit 28 for collecting the target 27. The laser light transmission device 50 includes an optical element for defining a transmission state of the laser light, and an actuator for adjusting the position, posture, and the like of the optical element.

Further, a buffer gas is supplied into the chamber 2 from a buffer gas supply device (not shown) to protect the EUV light concentrating mirror 23 from fragment debris generated during plasma generation. In the chamber 2, the buffer gas supplied from a supply port of the buffer gas supply device flows toward a dust removing device (not shown), and a flow field is formed. The buffer gas is hydrogen, nitrogen, or a noble gas such as helium and argon.

### 1.2 Operation

Referring to FIG. 1, operation of an exemplary LPP EUV light generation system 11 will be described. The pulse laser light 31 output from the laser device 3 enters, via the laser light transmission device 50, the chamber 2 through the window 21. The pulse laser light 31 having entered the chamber 2 travels along a laser light path in the chamber 2, is concentrated by the laser light concentrating optical system 60, and is radiated to the target 27.

The target supply device 25 outputs the target 27 toward the plasma generation region R1 in the chamber 2. The target 27 is irradiated with the pulse laser light 31. The target 27 irradiated with the pulse laser light 31 is turned into plasma, and radiation light 32 is radiated from the plasma. EUV light 33 contained in the radiation light 32 is selectively reflected by the EUV light concentrating mirror 23. The EUV light 33 reflected by the EUV light concentrating mirror 23 is concentrated at the intermediate focal point IF and output to the external apparatus 6. Here, one target 27 may be irradiated with a plurality of pulses included in the pulse laser light 31.

The processor 5 controls the entire EUV light generation system 11. Based on the detection result of the target sensor 4, the processor 5 controls timing at which the target 27 is output, an output direction of the target 27, and the like. Further, the processor 5 controls oscillation timing of the laser device 3, a travel direction of the pulse laser light 31, the concentration position, and the like. The above-described various kinds of control are merely examples, and other control may be added as necessary.

### 2. EUV Light Generation System According to Comparative Example

### 2.1 Configuration

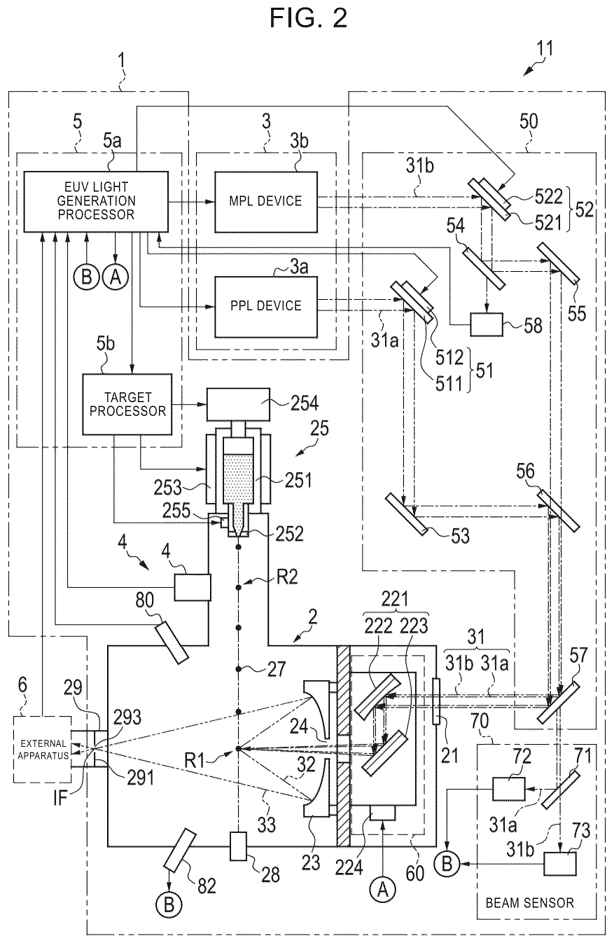

FIG. 2 schematically shows the configuration of the EUV light generation system 11 according to a comparative example. The EUV light generation apparatus 1 according to the comparative example includes a laser energy sensor 58, a beam sensor 70, a target size sensor 80, and an EUV energy sensor 82 in addition to the chamber 2, the target supply device 25, the processor 5, the target sensor 4, the laser light transmission device 50, and the laser light concentrating optical system 60.

The laser device 3 outputs a plurality of beams of the pulse laser light 31 to be radiated to each of the targets 27 supplied to the plasma generation region R1. The laser device 3 outputs, as the plurality of beams of the pulse laser light 31, for example, prepulse laser light 31a and main pulse laser light 31b in this order. Hereinafter, prepulse laser is referred to as “PPL”, and main pulse laser is referred to as “MPL.”

The laser device 3 includes a PPL device 3a that outputs PPL light 31a and a MPL device 3b that outputs MPL light 31b. The PPL device 3a is a YAG laser device or a laser device using Nd:YVO4. The MPL device 3b is, for example, a CO₂ laser device. Here, the MPL device 3b may be a YAG laser device or a laser device using Nd:YVO₄.

The processor 5 includes an EUV light generation processor 5a and a target processor 5b. The EUV light generation processor 5a controls the laser device 3, the laser light transmission device 50, and the like. The target processor 5b controls the target supply device 25.

The EUV light generation processor 5a is configured by, for example, a central processing unit (CPU). The EUV light generation processor 5a executes various types of processing described above based on a program stored in a memory which is built in or connected. Some or all of the functions of the EUV light generation processor 5a may be realized by using an integrated circuit such as a field programmable gate array (FPGA) or an application specific integrated circuit (ASIC).

The target supply device 25 includes a tank 251, a nozzle 252, a heater 253, a pressure regulator 254, and a piezoelectric element 255. The heater 253, the pressure regulator 254, and the piezoelectric element 255 are controlled by the target processor 5b.

The target sensor 4 includes a light receiving element or an imaging element, an illumination device, and a high-speed shutter, detects the passage timing, the generation interval, the velocity, and the like of the target 27 passing through the target detection region R2, and outputs a detection signal to the EUV light generation processor 5a. Hereinafter, a signal indicating a timing at which the target 27 passes through the target detection region R2 is referred to as a “target passage timing signal.” The target passage timing signal is included in the detection signal output from the target sensor 4.

The laser light transmission device 50 includes reflection control mirrors 51, 52, high reflection mirrors 53, 55, a combiner element 56, and beam splitters 54, 57.

The reflection control mirror 51 includes a high reflection mirror 511 and a stage 512. The high reflection mirror 511 is mounted on the stage 512 and is arranged at a position where the PPL light 31a output from the PPL device 3a is incident. The stage 512 is an actuator that changes the angle of the high reflection mirror 511. The stage 512 is controlled by the EUV light generation processor 5a.

The reflection control mirror 52 includes a high reflection mirror 521 and a stage 522. The high reflection mirror 521 is mounted on the stage 522 and is arranged at a position where the MPL light 31b output from the MPL device 3b is incident. The stage 522 is an actuator that changes the angle of the high reflection mirror 521. The stage 522 is controlled by the EUV light generation processor 5a.

The high reflection mirror 53 is arranged at a position such that the PPL light 31a reflected by the reflection control mirror 51 is reflected to be incident on the combiner element 56.

The beam splitter 54 is arranged on the optical path of the MPL light 31b reflected by the reflection control mirror 52. The beam splitter 54 is configured to reflect the MPL light 31b at a high reflectance and to transmit a part of the MPL light 31b toward the laser energy sensor 58.

The high reflection mirror 55 is arranged at a position such that the MPL light 31b reflected by the beam splitter 54 is reflected to be incident on the combiner element 56.

The reflection control mirror 51 and the high reflection mirror 53 are arranged such that the PPL light 31a can enter the laser light concentrating optical system 60 with a target optical performance. The reflection control mirror 52 and beam splitter 54 are arranged such that the MPL light 31b can enter the laser light concentrating optical system 60 with a target optical performance. Here, the optical performance is the position or the angle of the optical axis.

The laser energy sensor 58 is arranged on the optical path of the MPL light 31b transmitted through the beam splitter 54. The laser energy sensor 58 measures the energy of the MPL light 31b transmitted through the beam splitter 54, and outputs the measurement value to the EUV light generation processor 5a. The laser energy sensor 58 is not limited to the above arrangement. The laser energy sensor 58 may be arranged such that any of the high reflection mirrors arranged on the optical path of the MPL light 31b is changed to a beam splitter to measure light transmitted therethrough.

The combiner element 56 is an element that reflects the PPL light 31a and transmits the MPL light 31b. The combiner element 56 is, for example, a polarization beam combiner, and combines the optical paths of the PPL light 31a and the MPL light 31b having polarization directions perpendicular to each other. The optical path of the PPL light 31a reflected by the combiner element 56 and the optical path of the MPL light 31b transmitted through the combiner element 56 are combined so as to substantially coincide with each other. Here, the combiner element 56 may be configured to reflect the MPL light 31b and transmit the PPL light 31a.

The PPL light 31a and the MPL light 31b whose optical paths are combined by the combiner element 56 are incident on the beam splitter 57. The beam splitter 57 reflects a part of each of the PPL light 31a and the MPL light 31b to enter the laser light concentrating optical system 60, and transmits the other part to enter the beam sensor 70. Here, the beam splitter 57 may be configured to transmit a part of each of the PPL light 31a and the MPL light 31b to enter the laser light concentrating optical system 60, and reflect the other part to enter the beam sensor 70. Hereinafter, for convenience of explanation, the PPL light 31a and the MPL light 31b may be simply referred to as the pulse laser light 31 without being distinguished from each other.

The laser light concentrating optical system 60 is arranged in the chamber 2. The laser light concentrating optical system 60 is arranged between the window 21 and the plasma generation region R1 on the optical path of the pulse laser light 31 transmitted through the window 21. The laser light concentrating optical system 60 includes a laser light concentrating mirror 221 and a manipulator 224.

The laser light concentrating mirror 221 reflects the pulse laser light 31 transmitted through the window 21 and concentrates the pulse laser light 31 on the plasma generation region R1. The laser light concentrating mirror 221 is mounted on the manipulator 224. The laser light concentrating mirror 221 includes an off-axis parabolic mirror 222 and a planar mirror 223. Here, the off-axis parabolic mirror 222 is a concave mirror. Note that the off-axis parabolic mirror 222 may be a convex mirror, and a spheroidal mirror may be used instead of the planar mirror 223.

The manipulator 224 is a stage that adjusts at least one of the position and the posture of the laser light concentrating mirror 221 so that the target 27 is irradiated with the pulse laser light 31. The manipulator 224 is controlled by the EUV light generation processor 5a.

The beam sensor 70 includes a beam splitter 71, a first optical axis sensor 72, and a second optical axis sensor 73. The beam splitter 71 is an element that reflects the PPL light 31a and transmits the MPL light 31b. The beam splitter 71 is, for example, a polarization beam splitter, and separates the optical paths of the PPL light 31a and the MPL light 31b having polarization directions perpendicular to each other. The PPL light 31a separated by the beam splitter 71 enters the first optical axis sensor 72, and the MPL light 31b enters the second optical axis sensor 73.

The first optical axis sensor 72 is a sensor that detects the optical performance of the PPL light 31a. The second optical axis sensor 73 is a sensor that detects the optical performance of the MPL light 31b. Each of the first optical axis sensor 72 and the second optical axis sensor 73 outputs a detection value of the optical performance to the EUV light generation processor 5a.

Here, a beam splitter may be arranged on an optical path through which only the PPL light 31a propagates, and the first optical axis sensor 72 may be arranged such that a part of the PPL light 31a that has transmitted through or has been reflected by the beam splitter is incident on the first optical axis sensor 72. Alternatively, a beam splitter may be arranged on an optical path through which only the MPL light 31b propagates, and the second optical axis sensor 73 may be arranged such that a part of the MPL light 31b that has transmitted through or has been reflected by the beam splitter is incident on the second optical axis sensor 73.

The beam sensor 70 measures the optical performance of the pulse laser light 31 immediately before entering the chamber 2 so that the pulse laser light 31 enters the chamber 2 with the target optical performance. In the comparative example, the beam sensor 70 measures the optical performance of the pulse laser light 31 immediately before entering the laser light concentrating optical system 60.

The target size sensor 80 is attached to the chamber 2. The target size sensor 80 is configured to include an imaging element, and measures a size of a later-described secondary target by imaging the plasma generation region R1, and outputs the measurement value to the EUV light generation processor 5a.

The EUV energy sensor 82 is attached to the chamber 2. The EUV energy sensor 82 measures the energy of the EUV light 33 included in the radiation light 32 emitted from the target 27 in the plasma generation region R1, and outputs the measurement value to the EUV light generation processor 5a. Here, a plurality of the EUV energy sensors 82 may be arranged. Hereinafter, the energy of the EUV light 33 is referred to as the EUV energy.

### 2.2 Operation

The operation of the EUV light generation system 11 according to the comparative example will be described. First, the EUV light generation processor 5a outputs, to the PPL device 3a, setting values of the pulse energy, the pulse width, the pulse waveform. and the like of the PPL light 31a. Further, the EUV light generation processor 5a outputs, to the MPL device 3b, setting values of the pulse energy, the pulse width, the pulse waveform, and the like of the MPL light 31b.

The target processor 5b controls the heater 253 of the target supply device 25 to heat the material of the target 27 in the tank 251 to a temperature higher than the melting point thereof to be melted. In the comparative example, the material of the target 27 is tin, and the tank 251 is filled with molten liquid tin.

When receiving a signal requesting generation of the EUV light from the external apparatus 6, the EUV light generation apparatus 1 transmits a droplet generation signal to the target processor 5b. When receiving the droplet generation signal, the target processor 5b controls the pressure in the tank 251 to a predetermined pressure via the pressure regulator 254. As a result, a jet of the liquid tin is output from the nozzle 252 at a constant velocity.

The target processor 5b applies a voltage having a predetermined waveform to the piezoelectric element 255 fixed to the nozzle 252 such that the targets 27 in a droplet form are generated from the jet of the liquid tin at a predetermined frequency. As a result, the jet of the liquid tin output from the nozzle 252 is turned into droplets. Then, a plurality of droplets are combined to generate the target 27 in a droplet form having a predetermined diameter. The target 27 is generated at a constant generation interval.

The target sensor 4 detects the timing at which the target 27 passes through the target detection region R2, and outputs a target passage timing signal representing the detected timing to the EUV light generation processor 5a. The target sensor 4 may detect the generation interval of the target 27 and the velocity of the target 27, and may output a detection signal to the EUV light generation processor 5a.

The EUV light generation processor 5a generates a first light emission trigger signal delayed by a first delay time from the target passage timing signal and outputs the first light emission trigger signal to the PPL device 3a. The PPL device 3a outputs the PPL light 31a having the target pulse energy, pulse width, and pulse waveform in accordance with the first light emission trigger signal.

The PPL light 31a is reflected by the reflection control mirror 51, the high reflection mirror 53, the combiner element 56, and the beam splitter 57 in the laser light transmission device 50, and enters the laser light concentrating optical system 60. The PPL light 31a is concentrated by the laser light concentrating optical system 60 and is radiated to the target 27. Here, the target 27 in the droplet form to be irradiated with the PPL laser light 31a is also referred to as a primary target.

The primary target is broken by the irradiation of the PPL light 31a, and becomes a secondary target spreading in a mist form. Here, the term “mist form” refers to a state in which micro-droplets, clusters, and the like are diffused by the primary target being broken by the PPL light 31a.

The EUV light generation processor 5a generates a second light emission trigger signal delayed by a second delay time from the target passage timing signal and outputs the second light emission trigger signal to the MPL device 3b. The MPL device 3b outputs the MPL light 31b having the target pulse energy, pulse width, and pulse waveform in accordance with the second light emission trigger signal.

The MPL light 31b is reflected by the reflection control mirror 52, the beam splitter 54, and the high reflection mirror 55 in the laser light transmission device 50, is transmitted through the combiner element 56, and is reflected by the beam splitter 57, thereby entering the laser light concentrating optical system 60. The MPL light 31b is concentrated by the laser light concentrating optical system 60 and is radiated to the target 27 as the secondary target. As a result, the secondary target is turned into plasma, and the radiation light 32 including the EUV light 33 is generated.

The MPL light 31b transmitted through the beam splitter 54 enters the laser energy sensor 58. The laser energy sensor 58 measures the energy of the MPL light 31b, and outputs the measurement value to the EUV light generation processor 5a.

The PPL light 31a transmitted through the beam splitter 57 enters the beam sensor 70, is reflected by the beam splitter 71, and enters the first optical axis sensor 72. The first optical axis sensor 72 measures the optical performance of the PPL light 31a and outputs the measurement value to the EUV light generation processor 5a.

The MPL light 31b transmitted through the beam splitter 57 enters the beam sensor 70, is transmitted through the beam splitter 71, and enters the second optical axis sensor 73. The second optical axis sensor 73 measures the optical performance of the MPL light 31b and outputs the measurement value to the EUV light generation processor 5a.

The EUV light generation processor 5a controls the angle of the reflection control mirror 51 so that the optical performance of the PPL light 31a measured by the first optical axis sensor 72 becomes a target value. Further, the EUV light generation processor 5a controls the angle of the reflection control mirror 52 so that the optical performance of the MPL light 31b measured by the second optical axis sensor 73 becomes a target value.

After the PPL light 31a is radiated to the primary target, the target size sensor 80 measures the size of the secondary target and outputs the measurement value to the EUV light generation processor 5a. After the MPL light 31b is radiated to the secondary target, the EUV energy sensor 82 measures the EUV energy and outputs the measurement value to the EUV light generation processor 5a.

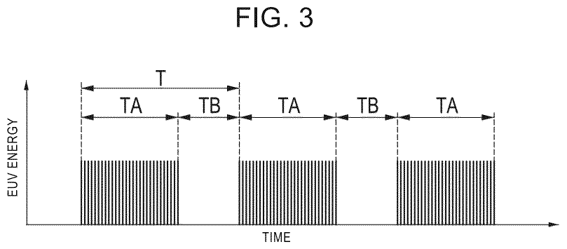

FIG. 3 shows an example of the operation of the EUV light generation system 11 according to the comparative example. In FIG. 3, the vertical axis represents the EUV energy and the horizontal axis represents time.

The EUV light generation system 11 may output the EUV light 33 by burst operation. The burst operation is an operation that repeats, at a certain repetition frequency, a burst period TA in which the EUV light 33 is output and a pause period TB in which the EUV light 33 is not output. During the burst period TA, the EUV light 33 is output. During the pause period TB, the output of the pulse laser light 31 is stopped or propagation of the pulse laser light 31 to the plasma generation region R1 is suppressed.

A burst pattern is defined by data including one or more of the EUV energy in the burst period TA, the repetition frequency, the number of pulses, duty DT, and the number of bursts. The burst pattern may be designated by the external apparatus 6.

The duty DT is a ratio of the burst period TA to one cycle T of a burst. Specifically, the duty DT is represented by DT=[TA/(TA+TB)]×100. The unit of the duty DT is %.

When the optical path axis of the pulse laser light 31 concentrated at the plasma generation region R1 deviates from the center of the target 27 during the burst operation, a problem such as a decrease of the EUV energy occurs. Since it is difficult to directly measure the deviation between the optical path axis of the pulse laser light 31 and the center of the target 27, the EUV light generation processor 5a controls the energy of the MPL light 31b so as to maintain the EUV energy constant. For example, the EUV light generation processor 5a controls the energy of the MPL light 31b so that the measurement value of the EUV energy by the EUV energy sensor 82 falls within a predetermined range. Hereinafter, the pulse energy of the MPL light 31b at the plasma generation region R1 is referred to as the MPL energy.

It is not easy to maintain the EUV energy constant only by controlling the MPL energy. Therefore, the EUV light generation processor 5a performs laser irradiation position control using the average value of the EUV energy or the EUV energy 3σ which is an index indicating the temporal variation of the EUV energy. Further, the EUV light generation processor 5a may perform the laser irradiation position control using CE which is an index indicating the conversion efficiency of the MPL energy to the EUV energy. Here, CE is a value obtained by dividing the average value of the EUV energy by the MPL energy. Hereinafter, the EUV energy 3σ is referred to as “E3σ.”

For example, E3σ is calculated by the following expression (1). The unit of E3σ is %.

[Expression 1]

E3σ=(3σ/μ)×100 (1)

Here, σ is a standard deviation of the EUV energy for a plurality of pulses included in a unit time. Further, μ is the average value of the EUV energy for multiple pulses included in the unit time. Therefore, in this case, E3σ is the value of three times the coefficient of variation expressed as a percentage.

The EUV light generation processor 5a may adjust a plurality of components of the EUV light generation system 11 so that the output performance of the EUV light 33 obtains a desired value. Such an adjustment is referred to as performance recovery. For example, the EUV light generation processor 5a performs performance recovery in the following cases. For example, the EUV light generation processor 5a performs performance recovery when an error for protecting the device is alerted during a continuously operating state and laser irradiation is stopped. For example, an error is alerted when a certain amount or more of fragment debris occurs. Further, upon receiving a signal indicating that the performance of the EUV light 33 does not satisfy the required performance from the external apparatus 6, the EUV light generation processor 5a performs performance recovery. Further, the EUV light generation processor 5a performs performance recovery when maintenance of the EUV light generation system 11 is performed. Examples of the maintenance include replacement of the EUV light concentrating mirror 23, replacement of the target supply device 25, and the like.

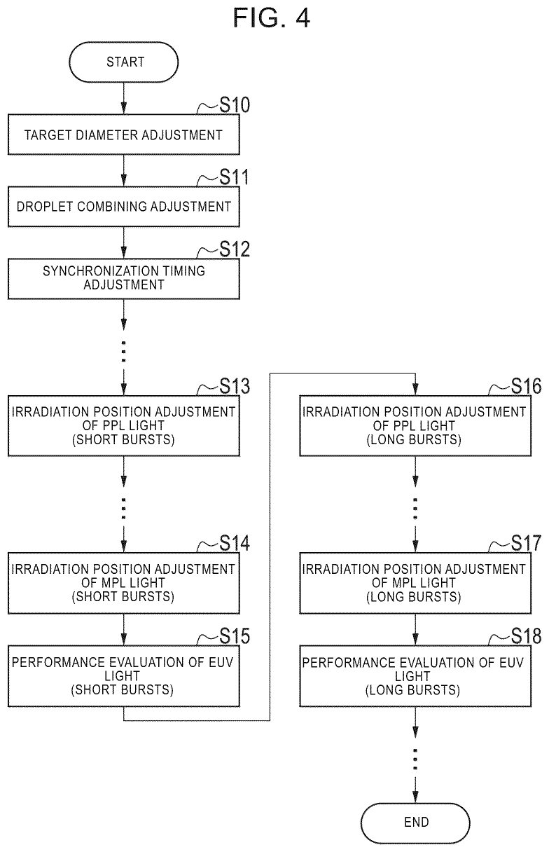

FIG. 4 shows the flow of performance recovery processing according to the comparative example. When generation of the EUV light 33 is stopped due to an error alert or the like, various factors are conceivable, and therefore, as shown in FIG. 4, the performance recovery processing includes a plurality of steps. In practice, the performance recovery processing includes 10 or more steps.

First, the EUV light generation processor 5a performs target diameter adjustment (step S10), droplet combining adjustment (step S11), and synchronization timing adjustment (step S12) as adjustment steps for the target 27.

The target diameter adjustment is a step of adjusting the frequency of the voltage waveform to be applied to the piezoelectric element 255 by the target processor 5b using the velocity of the target 27 detected by the target sensor 4 as an index. The diameter of the target 27 changes in accordance with the frequency of the voltage waveform.

The droplet combining adjustment is a step of adjusting the voltage waveform to be applied to the piezoelectric element 255 by the target processor 5b using the generation interval of the target 27 detected by the target sensor 4 as an index. For example, in the droplet combining adjustment, the duty of the voltage waveform is adjusted. The combining state of the droplet changes in accordance with the duty of the voltage waveform.

The synchronization timing adjustment is a step of adjusting the first delay time and the second delay time for generating the first light emission trigger signal and the second light emission trigger signal using the passage timing of the target 27 detected by the target sensor 4 as an index.

Next, the EUV light generation processor 5a performs irradiation position adjustment of the PPL light 31a (step S13), irradiation position adjustment of the MPL light 31b (step S14), and performance evaluation of the EUV light 33 (step S15) with short bursts each having a short burst period TA. With short bursts, adjustment can be performed while ignoring the effect of a thermal load. The thermal load refers to, for example, the amount of heat generated by plasma heating. As the density of the buffer gas changes due to plasma heating, position variation of the target 27 occurs.

The irradiation position adjustment of the PPL light 31a is a step of adjusting the irradiation position of the PPL light 31a with respect to the primary target using the size of the secondary target measured by the target size sensor 80 as an index. For example, the EUV light generation processor 5a controls the manipulator 224 to change the position of the laser light concentrating optical system 60, thereby adjusting the irradiation position of the PPL light 31a. The size of the secondary target changes in accordance with the irradiation position of the PPL light 31a.

The irradiation position adjustment of the MPL light 31b is a step of adjusting the irradiation position of the MPL light 31b with respect to the secondary target using CE as an index. For example, the EUV light generation processor 5a controls the stage 522 to change the posture of the high reflection mirror 521, thereby adjusting the irradiation position of the MPL light 31b. CE changes in accordance with the irradiation position of the MPL light 31b.

The performance evaluation of the EUV light 33 is a step of evaluating the performance of the EUV light 33 using the average value of the EUV energy in one burst period, E3σ, or CE as an index.

Next, the EUV light generation processor 5a performs irradiation position adjustment of the PPL light 31a (step S16), irradiation position adjustment of the MPL light 31b (step S17), and performance evaluation of the EUV light 33 (step S18) with long bursts each having a long burst period TA. With long bursts, adjustment can be performed including the effect of position variation of the target 27 due to a thermal load.

The irradiation position adjustment of the PPL light 31a, the irradiation position adjustment of the MPL light 31b, and the performance evaluation of the EUV light 33 with long bursts are similar to those with short bursts except that the length of the burst period TA differs.

### 2.3 Problem

As described above, the EUV light generation system 11 according to the comparative example needs to perform 10 or more steps every time to perform the performance recovery processing. The performance recovery processing may take several hours. Therefore, when generation of the EUV light 33 is stopped due to an error alert or the like, it is difficult to return rapidly to a state in which the performance of the EUV light 33 is secured by performing the performance recovery processing. Thus, it is an object to realize a rapid return to a condition in which the performance of the EUV light 33 is secured.

### 3. EUV Light Generation System According to First Embodiment

The EUV light generation system 11 according to a first embodiment will be described. Any component same as that described above is denoted by an identical reference sign, and duplicate description thereof is omitted unless specific description is needed.

### 3.1 Configuration

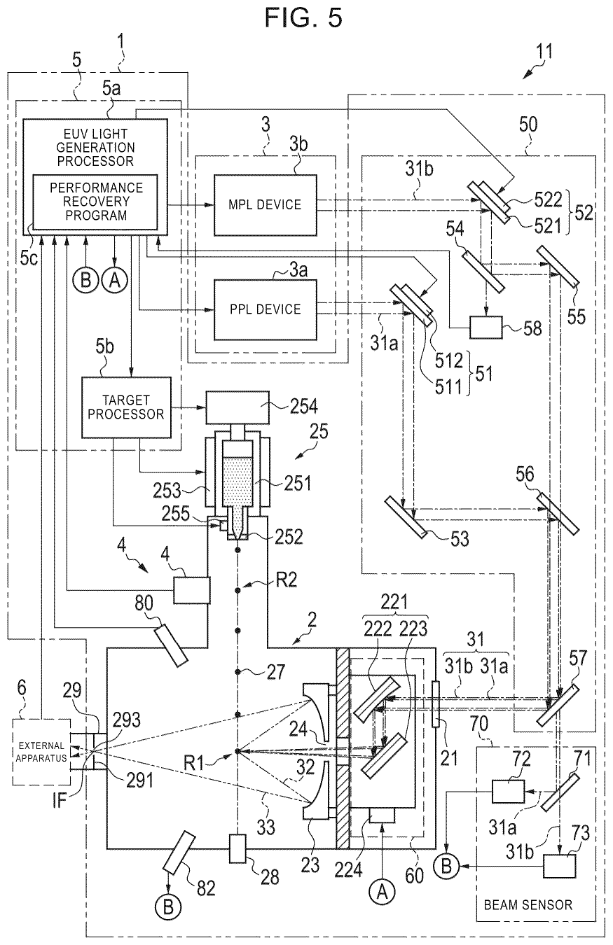

FIG. 5 shows the configuration of the EUV light generation system 11 according to the first embodiment. The configuration of the EUV light generation system 11 according to the present embodiment is similar to that of the comparative example except that the EUV light generation processor 5a is configured to perform the performance recovery processing based on a performance recovery program 5c stored in the memory.

### 3.2 Operation

The operation of the EUV light generation system 11 according to the first embodiment will be described. The operation of the EUV light generation system 11 according to the first embodiment is similar to that of the comparative embodiment except for the performance recovery processing.

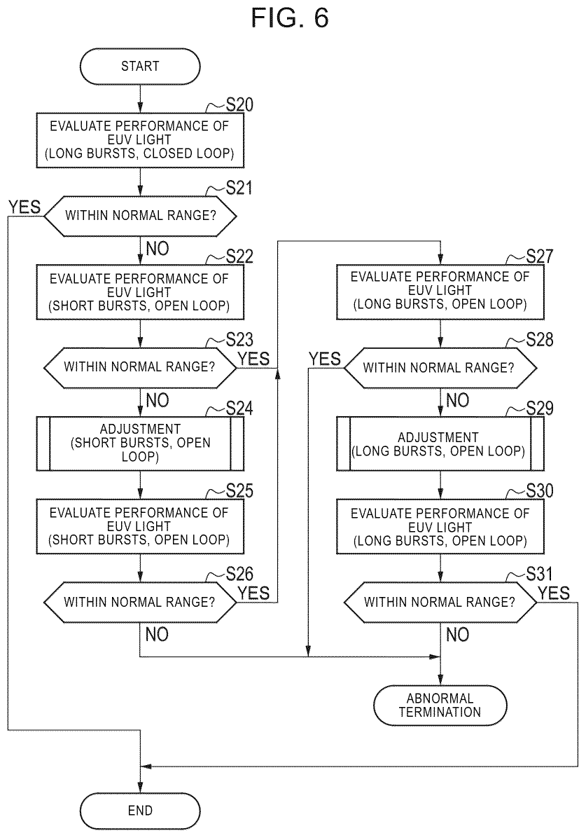

FIG. 6 shows the flow of the performance recovery processing according to the first embodiment. In the present embodiment, when the generation of the EUV light 33 is stopped due to an error alert or the like, the EUV light generation processor 5a performs the performance recovery processing shown in FIG. 6 based on the performance recovery program 5c. Hereinafter, the performance of the EUV light 33 is evaluated by evaluating an index relating to the irradiation position of the pulse laser light 31 with respect to the target 27. This index is the average value of the EUV energy in one burst period, E3σ, or CE.

In the present embodiment, first, the EUV light generation processor 5a evaluates the performance of the EUV light 33 with long bursts under closed loop (step S20). Here, long bursts under closed loop is an irradiation condition simulating a state in which the EUV light generation system 11 is continuously operated. For example, long bursts denote burst operation having a burst period TA of about 1 second. The pause period TB is longer than 1 second and the duty DT is less than 50%. The number of pulses included in the burst period TA is about 20,000. A closed loop refers to feedback control for maintaining the EUV energy constant. In step S20, feedback control is performed on the MPL energy, the irradiation position of the PPL light 31a, and the irradiation position of the MPL light 31b.

The EUV light generation processor 5a determines whether or not the evaluation result obtained in step S20 is within a normal range (step S21). Here, the evaluation result of being within the normal range means that the measurement value of the above-described index is within the normal range. When the evaluation result is within the normal range (step S21:YES), the EUV light generation processor 5a ends the performance recovery processing.

When the evaluation result is not within the normal range (step S21:NO), the EUV light generation processor 5a evaluates the performance of the EUV light 33 with short bursts under open loop (step S22). Here, short bursts under open loop is a short term irradiation condition in which the effect of a thermal load can be ignored. For example, short bursts denote burst operation having a burst period TA of 0.01 milliseconds or more and 10 milliseconds or less. The pause period TB is longer than 1 second and the duty DT is less than 50%. Under the open loop, the EUV light 33 is generated without performing feedback control for maintaining the EUV energy constant. In this case, the EUV light generation processor 5a performs performance evaluation of the EUV light 33 using the above-described index with the setting value of the MPL energy given to the MPL device 3b constant and without performing feedback control on the MPL energy. The burst period TA of short bursts is an example of the “first period” according to the technology of the present disclosure.

The EUV light generation processor 5a determines whether or not the evaluation result obtained in step S22 is within a normal range (step S23). This normal range may be different from that of step S21 for closed loop. Here, steps S22, S23 are examples of the “first evaluation step” according to the technology of the present disclosure.

When the evaluation result is within the normal range (step S23:YES), the EUV light generation processor 5a advances processing to step S27 without performing an adjustment process and a check process, which will be described later.

When the evaluation result is not within the normal range (step S23:NO), the EUV light generation processor 5a performs the later-described adjustment process with short bursts under open loop (step S24). Thereafter, the EUV light generation processor 5a evaluates the performance of the EUV light 33 again with short bursts under open loop (step S25).

The EUV light generation processor 5a determines whether or not the evaluation result obtained in step S25 is within a normal range (step S26). This normal range is the same as that of step S23. Here, steps S25, S26 are examples of the “check step” according to the technology of the present disclosure.

When the evaluation result is within the normal range (step S26:YES), the EUV light generation processor 5a advances processing to step S27. On the other hand, when the evaluation result is not within the normal range (step S26:NO), the EUV light generation processor 5a ends the performance recovery processing as abnormal termination.

In step S27, the EUV light generation processor 5a evaluates the performance of the EUV light 33 with long bursts under open loop. For example, long bursts denote burst operation having a burst period TA of 50 milliseconds or more and 10 seconds or less. The pause period TB is longer than 1 second and the duty DT is less than 50%. Step S27 is similar to step S22 except that the burst period TA differs. The burst period TA of long bursts is an example of the “second period” according to the technology of the present disclosure.

The EUV light generation processor 5a determines whether or not the evaluation result obtained in step S27 is within a normal range (step S28). This normal range may be different from that of step S21 for closed loop. Here, steps S27, S28 are examples of the “second evaluation step” according to the technology of the present disclosure.

When the evaluation result is within the normal range (step S28:YES), the EUV light generation processor 5a ends the performance recovery processing as abnormal termination. This is because it is considered that the evaluation result under closed loop is out of the normal range due to an unknown cause, and it is difficult to recover the performance of the EUV light 33 in the present performance recovery processing, that is, it is considered that further adjustment is necessary. Alternatively, when the determination result in step S28 is YES, performance evaluation with long bursts under closed loop (step S20) may be performed again instead of abnormal termination. It is also possible that, when the evaluation result of the performance evaluation with long bursts under closed loop (step S20) performed again is within the normal range (step S21:YES), the performance recovery processing is ended, and that, when the evaluation result is not within the normal range (step S21:NO), abnormal termination is caused.

When the evaluation result is not within the normal range (step S28:NO), the EUV light generation processor 5a performs the later-described adjustment process with long bursts under open loop (step S29). Thereafter, the EUV light generation processor 5a evaluates the performance of the EUV light 33 again with long bursts under open loop (step S30).

The EUV light generation processor 5a determines whether or not the evaluation result obtained in step S30 is within a normal range (step S31). This normal range is the same as that of step S28. Here, steps S30, S31 are examples of the “second check step” according to the technology of the present disclosure.

When the evaluation result is within the normal range (step S31:YES), the EUV light generation processor 5a ends the performance recovery processing. On the other hand, when the evaluation result is not within the normal range (step S31:NO), the EUV light generation processor 5a ends the performance recovery processing as abnormal termination.

When the EUV light generation processor 5a is abnormally terminated, for example, an abnormality is alerted by displaying an abnormality notification message on an external monitor.

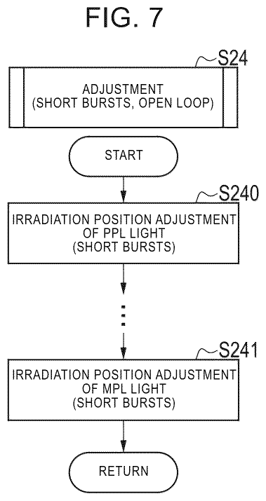

FIG. 7 shows an example of the adjustment step (step S24) with short bursts under open loop. In the adjustment step, the EUV light generation processor 5a performs irradiation position adjustment of the PPL light 31a (step S240), and irradiation position adjustment of the MPL light 31b (step S241). These irradiation position adjustments are similar to those in steps S13, S14 shown in FIG. 4 and described in the comparative example. The irradiation position adjustment of the PPL light 31a (step S240) and the irradiation position adjustment of the MPL light 31b (step S241) may be alternately performed a plurality of times. The irradiation position adjustment with short bursts under open loop is performed under an irradiation condition in which the effect of positional variation of the target 27 due to a thermal load can be ignored, and thus is a coarse adjustment for adjusting the irradiation position with low accuracy.

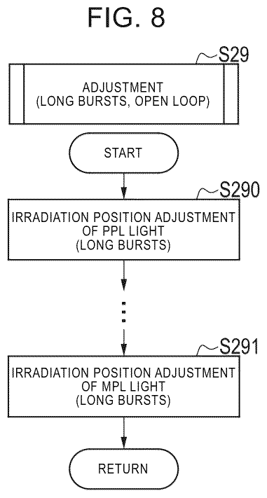

FIG. 8 shows an example of the adjustment step (step S29) with long bursts under open loop. In the adjustment step, the EUV light generation processor 5a performs irradiation position adjustment of the PPL light 31a (step S290), and irradiation position adjustment of the MPL light 31b (step S291). These irradiation position adjustments are similar to those in steps S16, S17 shown in FIG. 4 and described in the comparative example. The irradiation position adjustment of the PPL light 31a (step S290) and the irradiation position adjustment of the MPL light 31b (step S291) may be alternately performed a plurality of times. The irradiation position adjustment with long bursts under open loop is performed under an irradiation condition including the effect of the positional variation of the target 27 due to a thermal load, and thus is a fine adjustment for adjusting the irradiation position with high accuracy. Here, the adjustment amount in the case with long bursts is smaller than that in the case with short bursts.

### 3.3 Effect

When the generation of EUV light 33 is stopped due to an error alert or the like, various factors are conceivable, but in the present embodiment, the evaluation step is performed on factors to be checked with priority, and the adjustment process and the check step are performed in accordance with the evaluation result in the evaluation step. In the present embodiment, the evaluation step is performed on the irradiation position of the pulse laser light 31 with respect to the target 27 as a factor to be checked with priority. Specifically, in the present embodiment, the first evaluation step of short term is performed, and when the evaluation result is not within the normal range, the adjustment step and the check step are performed. As a result of the check step, when the evaluation result is within the normal range, the second evaluation step of long term is performed, and when the evaluation result is not within the normal range, processing is terminated. Thus, in the present embodiment, since the number of steps to be performed in the performance recovery step can be reduced, when generation of the EUV light 33 is stopped due to an error alert or the like, it is possible to return rapidly to a state in which the performance of the EUV light 33 is secured.

### 4. EUV Light Generation System According to Second Embodiment

Next, the EUV light generation system 11 according to a second embodiment will be described.

### 4.1 Configuration

The configuration of the EUV light generation system 11 according to the second embodiment is similar to that of the first embodiment except that the content of the processes defined in the performance recovery program 5c differs.

### 4.2 Operation

The operation of the EUV light generation system 11 according to the second embodiment will be described. The operation of the EUV light generation system 11 according to the second embodiment is similar to that of the comparative embodiment except for the performance recovery processing.

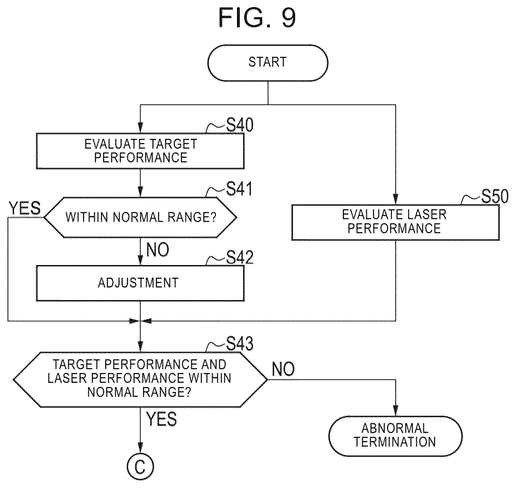

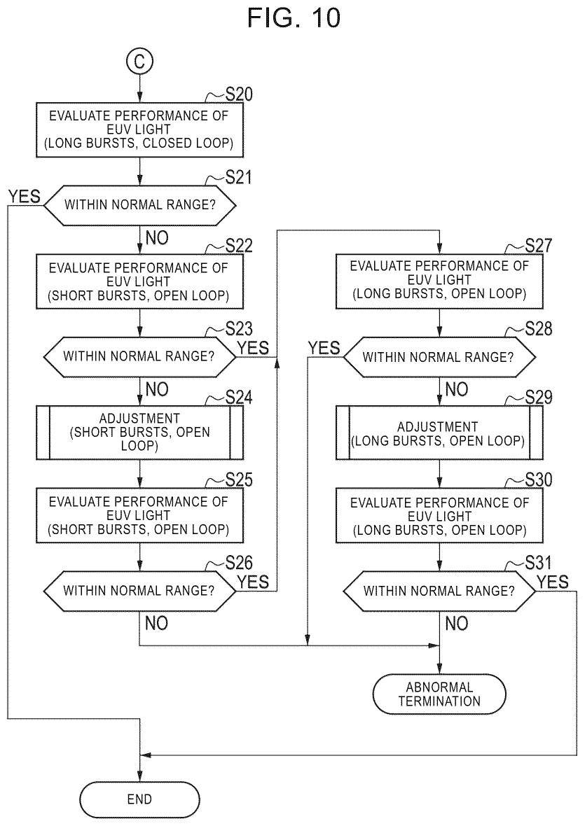

FIGS. 9 and 10 show the flow of the performance recovery processing according to the second embodiment. In the present embodiment, evaluation of the target performance and evaluation of the laser performance are performed before the performance recovery processing according to the first embodiment is performed, and the performance recovery processing according to the first embodiment is performed when the target performance and the laser performance are within the respective normal ranges. Here, the target performance refers to the performance of the target 27. The laser performance refers to the performance of the pulse laser light 31. The target performance is acquired by the target sensor 4. The laser performance is the optical performance described in the comparative example, and is acquired by the beam sensor 70.

In the present embodiment, when generation of the EUV light 33 is stopped due to an error alert or the like, the EUV light generation processor 5a performs evaluation of the target performance (step S40) and evaluation of the laser performance (step S50). Step S40 is an example of the “third evaluation step” according to the technology of the present disclosure. Step S50 is an example of the “fourth evaluation step” according to the technology of the present disclosure.

In step S40, the EUV light generation processor 5a evaluates indices by using the velocity and the generation interval of the target 27 as indices. The EUV light generation processor 5a determines whether or not each evaluation result is within the normal range (step S41). The normal range is different for each index. Here, the index related to the target performance may be one or more.

When the evaluation results are within the respective normal ranges (step S41:YES) for all indices, the EUV light generation processor 5a advances processing to step S43.

When any of the evaluation results is not within the normal range (step S41:NO), the EUV light generation processor 5a performs adjustment for an index that is not within the normal range (step S42). For example, when the velocity of the target 27 is not within the normal range, the target diameter adjustment described in the comparative example is performed. Further, when the generation interval of the target 27 is not within the normal range, the droplet combining adjustment described in the comparative example is performed. When such adjustment is performed, the adjusted index is evaluated again. After step S42, the EUV light generation processor 5a advances processing to step S43.

In step S50, the EUV light generation processor 5a evaluates the laser performance using the position or the angle of the optical axis of the pulse laser light 31 as an index. Specifically, the index of the laser performance is acquired for each of the PPL light 31a and the MPL light 31b. Here, the energy, the divergence, the pulse width, or the like may be used as the index of the laser performance. The index related to the laser performance may be one or more. After step S50, the EUV light generation processor 5a advances processing to step S43.

In step S43, the EUV light generation processor 5a determines whether or not the target performance and the laser performance are within the respective normal ranges. When the evaluation result is not within the normal range (step S43:NO) for either the target performance or the laser performance, the EUV light generation processor 5a ends the performance recovery processing as abnormal termination.

When the evaluation results for all indices of the target performance and the laser performance are within the respective normal ranges (step S43:YES), the EUV light generation processor 5a advances processing to step S20. The processes of step S20 and later are the same as those in the performance recovery processing according to the first embodiment.

### 4.3 Effect

In the present embodiment, since the performance recovery processing related to the EUV light 33 is performed when the target performance and the laser performance are within the respective normal ranges, probability of abnormal termination of the performance recovery processing is reduced, that is, the success rate of the performance recovery is improved compared to the first embodiment.

In the present embodiment, evaluation of both the target performance and the laser performance is performed, but evaluation of only one of the target performance and the laser performance may be performed. Further, steps S41, S42 may be omitted.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. A performance recovery method for an EUV light generation system generating EUV light by irradiating a target with pulse laser light, the performance recovery method comprising:
performing a first evaluation step of evaluating performance of the EUV light while generating the EUV light at a certain repetition frequency during a first period;
performing, when an evaluation result of the first evaluation step is not within a normal range, an adjustment step of adjusting the performance and then the first evaluation step as a check step;
performing, when an evaluation result of the check step is within the normal range, a second evaluation step of evaluating performance of the EUV light while generating the EUV light at the repetition frequency during a second period longer than the first period; and
terminating processing when the evaluation result of the check step is not within the normal range,
an index related to an irradiation position of the pulse laser light with respect to the target being evaluated in the first evaluation step and the second evaluation step.

2. The performance recovery method for the EUV light generation system according to claim 1,
wherein the index is a value indicating an average value of an energy of the EUV light or temporal variation of the energy of the EUV light.

3. The performance recovery method for the EUV light generation system according to claim 1,
wherein the index is a value obtained by dividing an average value of the energy of the EUV light by a pulse energy of the pulse laser light.

4. The performance recovery method for the EUV light generation system according to claim 1,
wherein the first period is 0.01 milliseconds or more and 10 milliseconds or less.

5. The performance recovery method for the EUV light generation system according to claim 1,
wherein the second period is 50 milliseconds or more and 10 seconds or less.

6. The performance recovery method for the EUV light generation system according to claim 1, further comprising:
performing the second evaluation step when the evaluation result of the first evaluation step is within the normal range.

7. The performance recovery method for the EUV light generation system according to claim 1, further comprising:
performing, before the first evaluation step, a third evaluation step of evaluating performance of the target,
wherein the first evaluation step is performed when an evaluation result of the third evaluation step is within a normal range.

8. The performance recovery method for the EUV light generation system according to claim 1, further comprising:
performing, before the first evaluation step, a fourth evaluation step of evaluating performance of the pulse laser light,
wherein the first evaluation step is performed when an evaluation result of the fourth evaluation step is within a normal range.

9. The performance recovery method for the EUV light generation system according to claim 1, further comprising:
performing, before the first evaluation step, a third evaluation step of evaluating performance of the target and a fourth evaluation step of evaluating performance of the pulse laser light,
wherein the first evaluation step is performed when an evaluation result of the third evaluation step and an evaluation result of the fourth evaluation step are both within respective normal ranges.

10. The performance recovery method for the EUV light generation system according to claim 7,
wherein a velocity or a generation interval of the target is evaluated in the third evaluation step.

11. The performance recovery method for the EUV light generation system according to claim 8,
wherein a position or an angle of an optical axis of the pulse laser light is evaluated in the fourth evaluation step.

12. An EUV light generation system generating EUV light by irradiating a target with pulse laser light,
the EUV light generation system comprising a processor,
the processor being configured to:
perform a first evaluation step of evaluating performance of the EUV light while generating the EUV light at a certain repetition frequency during a first period;
perform, when an evaluation result of the first evaluation step is not within a normal range, an adjustment step of adjusting the performance and then the first evaluation step as a check step;
perform, when an evaluation result of the check step is within the normal range, a second evaluation step of evaluating performance of the EUV light while generating the EUV light at the repetition frequency during a second period longer than the first period; and
terminate processing when the evaluation result of the check step is not within the normal range, and
an index related to an irradiation position of the pulse laser light with respect to the target being evaluated in the first evaluation step and the second evaluation step.

13. A processor to be used for an EUV light generation system generating EUV light by irradiating a target with pulse laser light,
the processor being configured to:
perform a first evaluation step of evaluating performance of the EUV light while generating the EUV light at a certain repetition frequency during a first period;
perform, when an evaluation result of the first evaluation step is not within a normal range, an adjustment step of adjusting the performance and then the first evaluation step as a check step;
perform, when an evaluation result of the check step is within the normal range, a second evaluation step of evaluating performance of the EUV light while generating the EUV light at the repetition frequency during a second period longer than the first period; and
terminate processing when the evaluation result of the check step is not within the normal range, and
an index related to an irradiation position of the pulse laser light with respect to the target being evaluated in the first evaluation step and the second evaluation step.
